(19) United States
(12) Patent Application Publication
(10) Pub. No.: US 2021/0368008 A1
(43) Pub. Date: Nov. 25, 2021

(54) NETWORK RESOURCE ACCESS

(71) Applicant: Hewlett-Packard Development Company, L.P., Spring, TX (US)

(72) Inventors: Daryl T. Poe, Fort Collins, CO (US); Daniel Bungert, Fort Collins, CO (US)

(73) Assignee: Hewlett-Packard Development Company, L.P., Spring, TX (US)

(21) Appl. No.: 17/045,499

(22) PCT Filed: Aug. 31, 2018
(86) PCT No.: PCT/US2018/049073

§ 371 Date: Oct. 6, 2020

(51) Int. Cl. H04L 29/08; H04L 29/06

(52) U.S. Cl. CPC H04L 67/141; H04L 69/14

(57) ABSTRACT

Examples associated with network resource access are described. One example method includes initiating a set of parallel connection requests to a network resource. The connection requests are generated using data retrieved from respective members of a set of resource identifiers. The resource identifiers specify connection information for accessing the network resource. A connection to the network resource is established based on a first responding member of the set of connection requests. Connection requests not associated with the first responding member of the set of connection requests are terminated. The network resource is accessed using the connection established based on the first responding member of the set of connection requests.

### BACKGROUND

Devices are connected to networks to allow the devices to communicate with one another as well as other resources on the network. The network may be, for example, a private network, a public network, the Internet, a wireless network, a wired network, and so forth.

### BRIEF DESCRIPTION OF THE DRAWINGS

The present application may be more fully appreciated in connection with the following detailed description taken in conjunction with the accompanying drawings.

FIG. 1 illustrates an example system associated with network resource access.

FIG. 2 illustrates a flowchart of example operations associated with network resource access.

FIG. 3 illustrates another flowchart of example operations associated with network resource access.

FIG. 4 illustrates an example system associated with network resource access.

FIG. 5 illustrates another flowchart of example operations associated with network resource access.

FIG. 6 illustrates an example computing device in which example systems, and methods, and equivalents, may operate.

### DETAILED DESCRIPTION

Examples associated with network resource access are described. When a process seeks to connect to a remote resource, the application may rely on a list of several alternative techniques and/or addresses for accessing the remote resource. While the process may seek to connect quickly to the resource, the connection may be delayed if the connection process used fails. The failure may be due to connectivity issues, invalidity of an address, unavailability of device accessed, and so forth. Upon failing to connect, some processes may initiate an alternative connection process. This may be slow if several connections attempts fail.

Instead, as disclosed herein, alternative connection attempts may be initiated in parallel with one another. When one of the connection attempts succeeds, in some examples, the other connection attempts may be terminated, and the successful connection may be used for accessing the resources. In other examples, priorities may be assigned to the various connection techniques and/or addresses to, for example, ensure the process connects to the network resource using relatively faster connection types. In these examples, when a connection attempt succeeds, connection attempts having a priority lower than the successful connection technique may be terminated, while others are permitted to continue. If a second connection attempt having a higher priority than the initial connection ultimately succeeds, the initial connection may be terminated and the second connection may be used instead.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, instructions stored on a computer-readable medium or in execution on a machine, and/or combinations of each to perform a function(s) or an action(s), and/or to cause a function or action from another module, method, and/or system. A module may include a microprocessor controlled via instructions executable by the microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

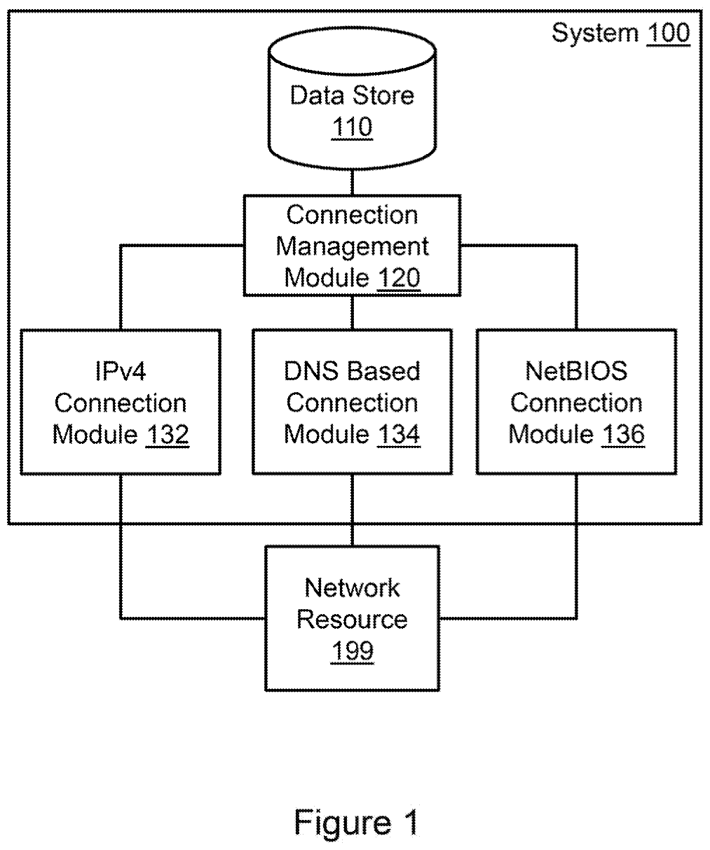

FIG. 1 illustrates an example system 100 associated with network resource access. System 100 may facilitate connecting a device in which system 100 is embedded to a network resource 199. Network resource 199 may be, for example, a server, an authentication system, and so forth. System 100 may be able to connect to network resource 199 using a variety of techniques and/or addresses. Information describing these techniques and/or addresses may be stored in a data store 110. Thus, data store 110 may store information describing a variety of ways network resource 199 may be contacted. Depending on whether network resource 199 is a single device or a distributed system, data store 110 may store different types of information. For example, if network resource 199 is embodied on a distributed set of devices and system 100, when connecting to network resource 199, seeks to connect to one member of the set of devices, data store 110 may store different addresses for each of the devices. If network resource 199 is a single device, data store 110 may store a set of addresses that use different protocols for connecting to network resource 199.

System 100 also includes a connection management module 120. Connection management module 120 may be responsible for controlling the establishment of a connection between system 100 and network resource 199. To that end, when system 100 seeks to connect to network resource 199, connection management module 120 may access data store 110 and a set of connection modules 132, 134, 136. Specifically, connection management module 120 may initialize instantiations of the connection modules based on the connection information in data store 110. By way of illustration, if data store 110 contains two IPv4 address, a domain name service string, and a NetBIOS address for accessing network resource 199, connection management module 120 may initiate two instantiations of IPv4 connection module 132, one instantiation of DNS based connection module 134, and one instantiation of connection module 136. These may be allowed to operate in parallel, potentially taking advantage of multi-core or otherwise parallel processing power available to system 100. As used herein, parallel operation of processes is intended to refer to the fact that the processes may be in execution at the same or substantially the same time, as opposed to waiting to initiate a process until another process has completed, failed, or otherwise terminated. Parallel execution may be achievable, for example, by different portions of a processor executing different processes (e.g., different cores of a multi-core processor), using threading, by executing operations associated with a first process while a second process is waiting for a response from a remote device or other component of system 100, and so forth.

Eventually, one of the instantiations of the connection modules may establish a connection between network resource 199 and system 100. When this occurs, connection management module 120 may take steps to terminate the other instantiations that are still seeking to connect to network resource 199. This may free up resources of system 100 when only a single connection between system 100 is needed, as well as ensure that system 100 does not overutilize resources of network resource 199.

By way of illustration, a device offering a virtual machine service may have multiple ethernet adaptors. One of these adaptors may be configured to be for administrator-only purposes, while others may be configured for general use. A remoted desktop broker may provide addresses for both adaptors to a device attempting to establish a connection to the virtual machine service, even though the administrator adaptor will block a connection from a general user. By attempting to connect to both adaptors in parallel, the connecting device may more quickly establish a connection to the virtual machine service.

In some examples, data store 110 may also store priority information associated with the connection information stored therein. The priority information may specify, for example, which connections are preferred for use by system 100, and so forth. As used herein, there may be many techniques used for specifying priority information. In some examples, the priority information may be based on connection attributes such as connection speed, latency, and so forth. In other examples, the priority information may be based on rules, policies, or other factors defined by, for example, a network administrator. When reference is made to priorities herein having a higher or lower priority, these terms are intended to refer relatively to policy values associated with other connections, connection request, resource identifiers, and so forth. When data store 110 includes priority information, connection management module 120 may selectively terminate connection modules once an initial connection between system 100 and network resource 199 is established. Specifically, connection management module 120 may terminate connection modules associated with connection information having a priority lower than or equal to a priority associated with the initial connection. Other connection modules may be allowed to continue operation, and if a second successful connection associated a higher priority than the initial connection, the initial connection may be terminated, and the second connection used for accessing network resource 199.

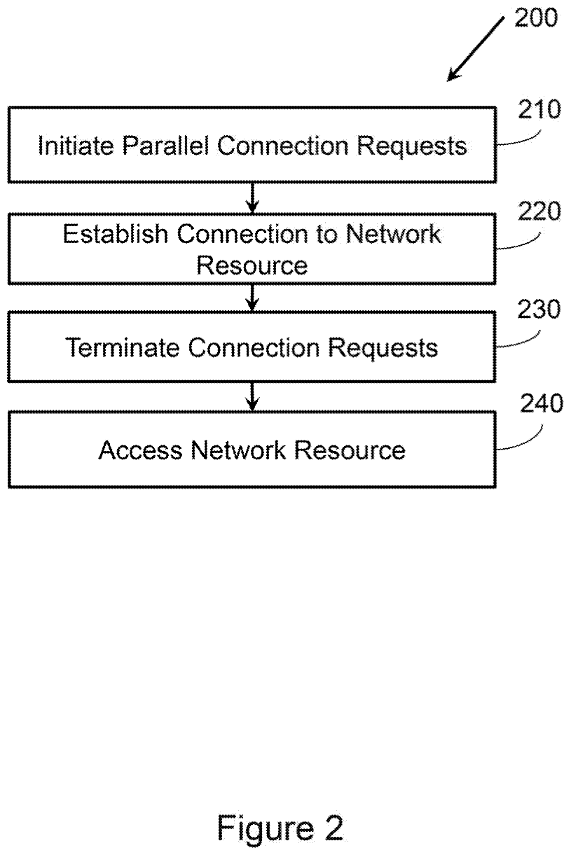

FIG. 2 illustrates an example method 200. Method 200 may be embodied on a non-transitory processor-readable medium storing processor-executable instructions. The instructions, when executed by a processor, may cause the processor to perform method 200. In other examples, method 200 may exist within logic gates and/or RAM of an application specific integrated circuit (ASIC).

Method 200 may perform various tasks associated with network resource access. Method 200 includes initiating a set of connection requests to a network resource at 210. The network requests may be initiated in parallel. The network requests may be generated using data retrieved from respective members of a set of resource identifiers. The resource identifiers may specify connection information for accessing the network resource. In one example, the network resource may be a single device. In this example, the resource identifiers may specify a variety of aliases for contacting the single device. By way of illustration, a device reachable via numerous ports and/or protocols may be identified by multiple resource identifiers. In other examples, the network resource may be accessible via a set of devices, and the resource identifiers may specify addresses for members of the set of devices. This may be appropriate, for example, when network resource 199 is a distributed service such as a content server where system 100 can obtain the same data from many of the devices on which the distributed service is illustrated. The aliases and/or addresses in the connection information may be, for example, partially qualified domain name strings, fully qualified domain name strings, IPv4 addresses, IPv6 addresses, NetBIOS names, and so forth.

Method 200 also includes establishing a connection to the network resource at 220. The connection may be established based on a first responding member of the set of connection requests. How the connection is established may depend on the protocol being used. Additionally, establishing the connection may also include testing the connection to ensure the connection is usable for a desired purpose. This testing may involve verifying, for example, bandwidth of the connection, latency of the connection, operation of the network resource, that the connected device has sought data stored thereon, and so forth.

Method 200 also includes terminating connection requests at 230. The connection requests terminated may be connection requests not associated with the first responding member of the set of connection requests. Terminating the connection requests may include terminating processes on a system performing method 200, transmitting a signal to the network resource that the connection attempt is terminated, ignoring signals received from the network resource associated with the terminated connections, closing completed connections to the network resource, and so forth.

Method 200 also includes accessing the network resource at 240. The network resource may be accessed using the connection established based on the first responding member of the set of connection requests. How the network resource is accessed may depend on the type of network resource being accessed.

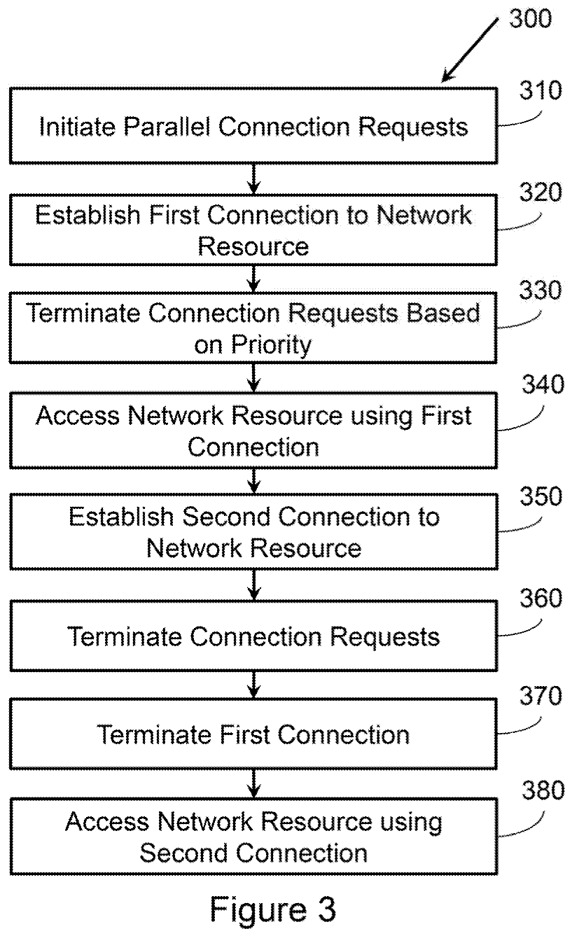

FIG. 3 illustrates a method 300 associated with network resource access. Method 300 includes several actions similar to those described above with reference to method 200 (FIG. 2). For example, method 300 includes initiating parallel connection requests to a network resource at 300, establishing a first connection to the network resource at 320, and accessing network resource using the first connection 340.

Method 300 also includes terminating connection requests at 330. Here, the connection requests terminated may be based on priority information. Specifically, resource identifiers associated with the connection requests may specify priority information for connections established based on the resource identifiers. Thus, terminated connection requests may include connection requests associated with a priority lower than a priority associated with the first responding member of the set of connection requests. Similarly, terminated connection requests may also include connection requests associated with a priority equal to the priority associated with the first responding member of the set of connection requests.

Eventually, a second connection to the network resource may be established at 350. The second connection may be established based on a second responding member of the set of connection requests. The second responding member of the set of connection requests may be associated with a priority higher than a priority associated with the first responding member of the set of connection requests.

When the second connection is established, connection requests not associated with the second responding member of the set of connection requests may be terminated at 360, the connection to the network resource associated with the first responding member of the set of connection requests may be terminated at 370, and the network resource may be accessed using the connection established based on the second responding member of the set of connection requests at 380. Similar to the process above, connection requests having a priority higher than the second responding member of the set of connection requests may remain unterminated to again attempt to use a higher priority connection technique.

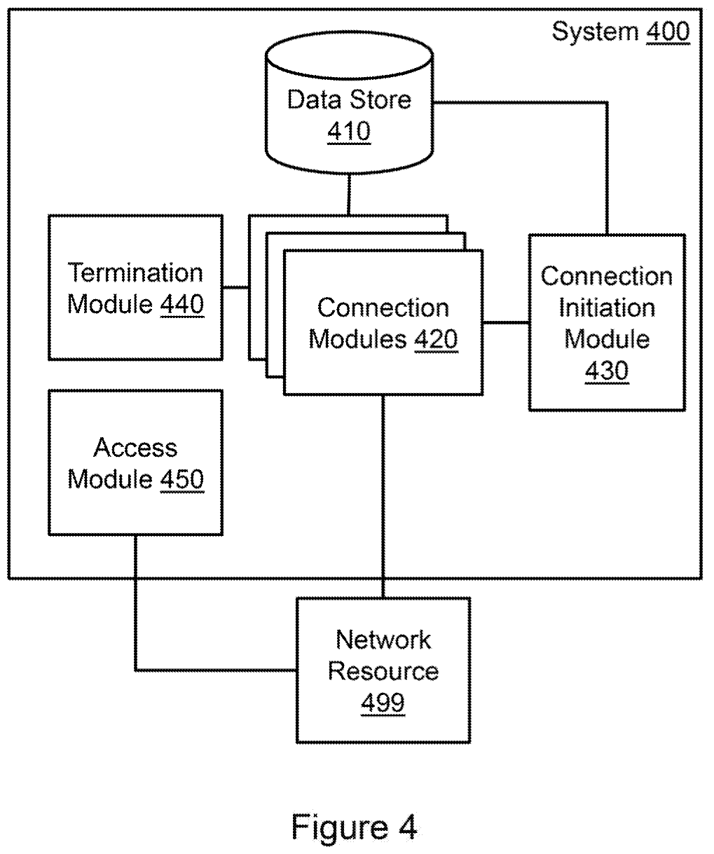

FIG. 4 illustrates a system 400 associated with network resource access. System 400 includes a data store 410. Data store 410 may store a set of resource identifiers. The resource identifiers may be associated with a network resource 499. The resource identifiers may specify address information for connecting system 400 to network resource 499. The resource identifiers may specify different addresses for a single device, addresses for several devices capable of offering the network resource, and so forth.

System 400 also includes a set of connection module 420. Members of the set of connection modules 420 may establish the connection to network resource 499 using differing network protocols. In various examples, connection initiation modules 420 may be configured to connect to network resource 499 using partially qualified domain name strings, fully qualified domain name strings, IPv4 addresses, IPv6 addresses, NetBIOS names, and so forth.

System 400 also includes a connection initiation module 430. Connection initiation module 430 may initiate parallelized instantiations of members of the set of connection modules 420. The instantiations may correspond to members of the set of resource identifiers from data store 410. In some examples, connection initiation module 430 may initiate a parallelized instantiation for each member of the set of resource identifiers in data store 410. Additionally, connection initiation module 430 may select members of the set of connection modules 430 for instantiation based on network protocols identified by members of the set of resource identifiers.

System 400 also includes a termination module 440. Termination module 440 may receive a signal from a first instantiated connection module indicating that the first instantiated connection module has established a first connection to network resource 499. In some examples, the first instantiated connection module may also determine that network resource 499 is accessible and usable prior to indicating to termination module 440 that the first instantiated connection module has established the first connection to the network resource. Upon receiving this signal, termination module 440 may terminate active instantiations of members of the set of connection modules 420. System 400 also includes an access module 450. Access module may access network resource 499 using the first connection to network resource 499.

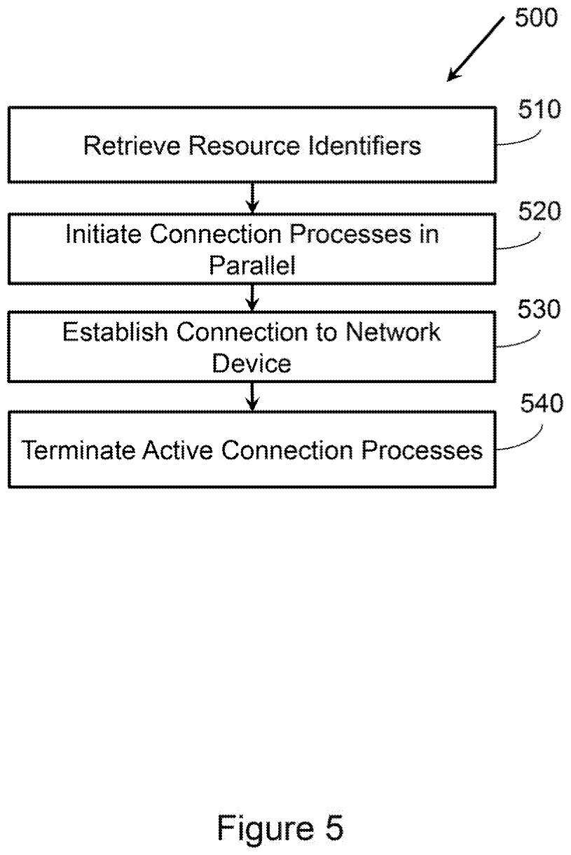

FIG. 5 illustrates a method 500 associated with network resource access. Method 500 includes retrieving a set of resource identifiers at 510. The resource identifiers may specify connection information associated with a network device, a set of network devices, and so forth. Method 500 also includes initiating connection processes in parallel at 520. The connection process may seek to establish a connection to the network device for each member for the set of resource identifiers.

Method 500 also includes establishing a connection to the network device at 530. The connection may be established upon successful completion of a first connection process to the network device. Method 500 also includes terminating remaining active connection processes at 540. In some examples, method 500 may also include accessing a resource on the network device (not shown). In other examples, method 500 may also include serving as a network resource to the network device (not shown).

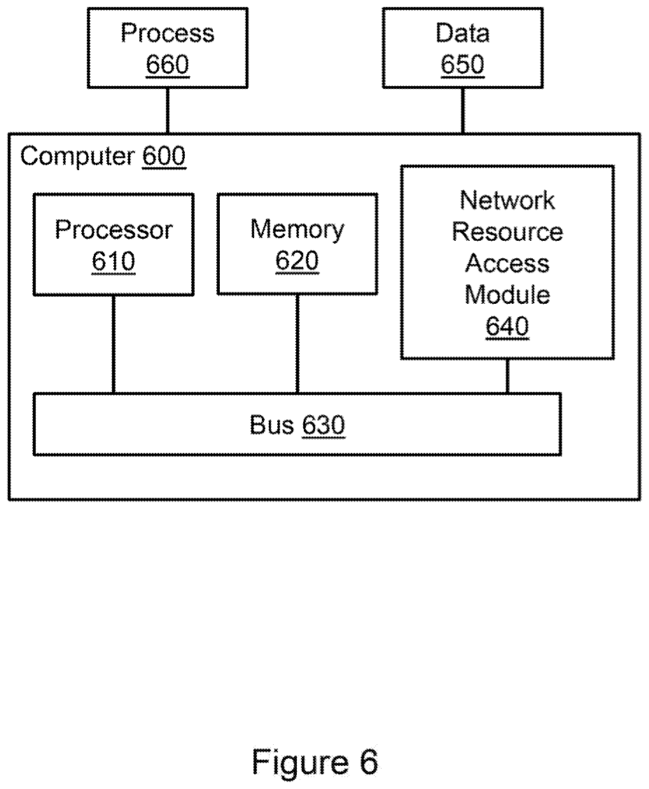

FIG. 6 illustrates an example computing device in which example systems and methods, and equivalents, may operate. The example computing device may be a computer 600 that includes a processor 610 and a memory 620 connected by a bus 630. Computer 600 includes a network resource access module 640. Network resource access module 640 may perform, alone or in combination, various functions described above with reference to the example systems, methods, and so forth. In different examples, network resource access module 640 may be implemented as a non-transitory computer-readable medium storing processor-executable instructions, in hardware, as an application specific integrated circuit, and/or combinations thereof.

The instructions may also be presented to computer 600 as data 650 and/or process 660 that are temporarily stored in memory 620 and then executed by processor 610. The processor 610 may be a variety of processors including dual microprocessor and other multi-processor architectures. Memory 620 may include non-volatile memory (e.g., read-only memory, flash memory, memristor) and/or volatile memory (e.g., random access memory). Memory 620 may also be, for example, a magnetic disk drive, a solid state disk drive, a floppy disk drive, a tape drive, a flash memory card, an optical disk, and so on. Thus, memory 620 may store process 660 and/or data 650. Computer 600 may also be associated with other devices including other computers, devices, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising:
initiating, in parallel, a set of connection requests to a network resource, where the connection requests are generated using data retrieved from respective members of a set of resource identifiers, where the resource identifiers specify connection information for accessing the network resource;
establishing a connection to the network resource based on a first responding member of the set of connection requests;
terminating connection requests not associated with the first responding member of the set of connection requests; and
accessing the network resource using the connection established based on the first responding member of the set of connection requests.

2. The method of claim 1, where the network resource is a single device, and the resource identifiers specify a variety of aliases for contacting the single device.

3. The method of claim 1, where the network resource is accessible via a set of devices, and where the resource identifiers specify addresses for members of the set of devices.

4. The method of claim 1, where the resource identifiers further specify priority information for connections established based on the resource identifiers, where the terminated connection requests include connection requests associated with a priority lower than a priority associated with the first responding member of the set of connection requests.

5. The method of claim 4, where the terminated connection requests also include connection requests associated with a priority equal to the priority associated with the first responding member of the set of connection requests.

6. The method of claim 4, further comprising:
establishing a connection to the network resource based on a second responding member of the set of connection requests, where the second responding member of the set of connection requests is associated with a priority higher than a priority associated with the first responding member of the set of connection requests;
terminating connection requests not associated with the second responding member of the set of connection requests;
terminating the connection to the network resource associated with the first responding member of the set of connection requests; and
accessing the network resource using the connection established based on the second responding member of the set of connection requests.

7. The method of claim 1, where the connection information associated with the network resource include one of, a partially qualified domain name string, a fully qualified domain name string, an IPv4 address, an IPv6 address, and a NetBIOS name.

8. A system, comprising:
a data store to store a set of resource identifiers associated with a network resource, where the resource identifiers specify address information for connecting with the network resource;
a set of connection modules for establishing a connection with the network resource, where members of the set of connection modules are to establish the connection to the network resource using differing network protocols;
a connection initiation module to initiate parallelized instantiations of members of the set of connection modules, where the instantiations correspond to members of the set of resource identifiers;
a termination module to in response to receiving a signal from a first instantiated connection module indicating that the first instantiated connection module has established a first connection to the network resource, terminate active instantiations of members of the set of connection modules; and
an access module to access the network resource using the first connection to the network resource.

9. The system of claim 8, where the connection initiation module initiates a parallelized instantiation of members of the set of connection modules for each member of the set of resource identifiers, and where the connection initiation module selects members of the set of connection modules for instantiation based on network protocols identified by members of the set of resource identifiers.

10. The system of claim 8, where the first instantiated connection module also determines that the network resource is accessible and usable prior to indicating to the termination module that the first instantiated connection module has established the first connection to the network resource.

11. The system of claim 8, where a connection initiation module is configured to connect to the network resource using one of, a partially qualified domain name string, a fully qualified domain name string, an IPv4 address, an IPv6 address, and a NetBIOS name.

12. A non-transitory computer-readable medium storing processor executable instructions that when executed control a processor to:
retrieve a set of resource identifiers that specify connection information associated with a network device;
initiate in parallel, connection processes attempting to establish a connection to the network device for each member of the set of resource identifiers;
establish a connection to the network device upon successful completion of a first connection process to the network device; and
terminate remaining active connection processes.

13. The non-tangible computer-readable medium of claim 12, where the instructions further control the processor to access a resource on the network device.

14. The non-tangible computer-readable medium of claim 12, where the instructions further control the processor to serve as a network resource to the network device.

15. The non-tangible computer-readable medium of claim 12, where the resource identifiers specify connection information associated with a set of network devices.
